(19) United States
(12) Patent Application Publication
(10) Pub. No.: US 2026/0044691 A1
(43) Pub. Date: Feb. 12, 2026

(54) SYSTEM AND METHOD FOR PROVIDING DATA TO NFC DEVICE

(71) Applicant: STMicroelectronics (China) Investment Co., Ltd, Shanghai (CN)

(72) Inventor: Dongyang TIAN, Suzhou (CN)

(73) Assignee: STMicroelectronics (China) Investment Co., Ltd, Shanghai (CN)

(21) Appl. No.: 19/102,324

(22) PCT Filed: Aug. 17, 2022
(86) PCT No.: PCT/CN2022/113152

§ 371 Date: Feb. 7, 2025

(51) Int. Cl. G06K 7/10

(52) U.S. Cl. CPC G06K 7/10297

(57) ABSTRACT

An NFC device and an NFC reader each includes NFC circuitry, an FFC antenna, and a controller. The NFC circuitry establishes an NFC connection between the NFC reader and the NFC device and may perform NFC functions such as NFC authentication. The NFC circuitry of the NFC device harvests energy from an NFC field received from the NFC reader. If the NFC reader has data for the NFC device, or if the NFC device has data for the NFC reader, then the data can be provided between the NFC reader and the NFC device via the FFC antennas.

### BACKGROUND

### Technical Field

The present disclosure relates to the field of near field communication (NFC). The present disclosure relates more particularly to upgrading firmware of an NFC device.

### Description of the Related Art

NFC technology utilizes radiofrequency signals to enable devices to communicate with each other in close proximity. Many applications of NFC technology utilize an NFC reader to interrogate and receive data from an NFC device. The NFC reader typically outputs an interrogation signal. If an NFC device is within range of the interrogation signal, then the NFC device responds by providing an identification signal identifying the NFC device. After the NFC device has identified itself, the NFC reader and the NFC device can further exchange information.

Some NFC devices may include a controller that controls the function of the NFC device. The controller may include firmware. Firmware corresponds to software that defines or controls the basic function of the NFC device. In some cases, it may be beneficial to upgrade the firmware of an NFC device. However, it can be relatively difficult to upgrade the firmware of an NFC device.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide NFC devices that are able to provide data updates for controllers, or transfer other types of large data files, in a simple and effective manner. An NFC device in accordance with principles of the present disclosure utilizes both NFC and far field communication (FFC) to effectively transmit or receive large data files. In particular, an NFC device in accordance with principles of the present disclosure includes an NFC antenna and an FFC antenna. When a large data file is to be transmitted or received, the NFC device utilizes the NFC antenna and other NFC circuitry to harvest energy from an external NFC field. The NFC device utilizes the harvested energy to power a controller that controls the FFC antenna to transmit or receive receive update data from to or from an external device.

In one embodiment, the NFC device is part of an electronic device that utilizes NFC to perform certain functions of the electronic device. For example, when the NFC devices in the presence of an NFC reader, the NFC device may receive an identification or command from the NFC reader. The NFC device may then cause the electronic device to perform an action responsive to the identification or command. In these situations, the NFC reader may communicate entirely by NFC. However, in some circumstances the NFC reader may have update data for the NFC device. In these cases, the NFC device may provide an FFC address to the NFC reader. The NFC reader may then provide the update data to the NFC device via FFC. Because FFC can transmit data at much higher data rates than NFC, the update data is quickly provided to the NFC device via FFC.

In some embodiments, the NFC device does not include a battery or other internal power source. Advantageously, the NFC device is powered entirely by harvesting energy from the NFC field provided by the NFC reader. Accordingly, the NFC device actively harvest energy from the NFC reader while communicating with the NFC reader via an FFC antenna. Because the FFC antenna is powered by energy harvested from the NFC field, the NFC device can operate without an internal battery for connection to another internal power source of the electronic device of which the NFC device is part.

In one embodiment, the NFC device is part of an electronic lock. The electronic lock does not include an internal battery. The internal electronic lock includes a motor and a locking mechanism. Because the electronic lock has no internal power source. The electronic lock utilizes NFC to harvest energy to activate the locking mechanism. The electronic lock can utilize FFC to receive updates while being powered by energy harvested from an external NFC field.

In one embodiment, a method includes establishing, with an NFC device, an NFC connection with an NFC reader, powering a controller of the NFC device by harvesting energy from an NFC field received from the NFC device, and establishing, with the NFC device, an FFC connection with the NFC reader. The method includes receiving, with the NFC device, update data from the NFC reader via the FFC connection while harvesting energy from the NFC field and updating data of the NFC device with the update data.

In one embodiment, an electronic system includes NFC circuitry including an NFC antenna, an FFC antenna, and a controller coupled to the NFC circuitry and to the NFC antenna.

In one embodiment, an electronic lock includes NFC circuitry including an NFC antenna, an FFC antenna, and a controller coupled to the NFC circuitry and to the NFC antenna. The electronic lock includes a motor coupled to the controller and a locking mechanism coupled to the motor.

In one embodiment, an electronic system includes an NFC reader configured to receive firmware update data. The NFC reader includes a first NFC antenna and a first FFC antenna. The system includes an NFC device. The NFC device includes NFC circuitry. The NFC device includes a second NFC antenna, a second FFC antenna, and a controller coupled to the NFC circuitry and the second FFC antenna.

In one embodiment, an electronic device includes an NFC antenna, an FFC antenna, and a controller coupled to the NFC antenna and the FFC antenna. The controller is configured to cause the NFC antenna to output an NFC field to establish an NFC connection with an NFC device and to establish an FFC connection with NFC device via the FFC antenna while the NFC antenna outputs the NFC field.

In one embodiment, a method includes receiving, with an NFC reader, firmware update data and establishing near field communication with an NFC device by outputting an NFC field from an NFC antenna. The method includes establishing FFC communication with the NFC device via an FFC antenna of the NFC reader and providing the firmware update data to the NFC device via the FFC antenna.

In one embodiment, a method includes receiving, with an NFC antenna of an NFC device, an NFC field from an NFC reader and generating a voltage by harvesting energy from the NFC field. The method includes powering a controller of the NFC device with the voltage and controlling an FFC antenna of the NFC device with the controller is powered by the voltage.

Embodiments of the present disclosure provide an NFC based firmware update process that is both simple and efficient. This obviates processes in which intrusive equipment and manual access procedures are utilized to perform firmware updates for NFC devices and for associated electronic devices and systems.

### BRIEF DESCRIPTION OF THE SEVERAL VIEWS OF THE DRAWINGS

FIG. 1 is a block diagram of an NFC system, according to one embodiment.

FIG. 2 is a block diagram of an NFC system, according to one embodiment.

FIG. 3 is a block diagram of an NFC system, according to one embodiment.

FIG. 4 is a schematic diagram of a portion of an NFC device, according to one embodiment.

FIG. 5 is a flow diagram of a process for operating an NFC system, according to one embodiment.

FIG. 6 is a flow diagram of a process for operating an NFC system, according to one embodiment.

FIG. 7 is a flow diagram of a process for operating an NFC system, according to one embodiment.

FIG. 8 is a flow diagram of a process for operating an NFC system, according to one embodiment.

### DETAILED DESCRIPTION

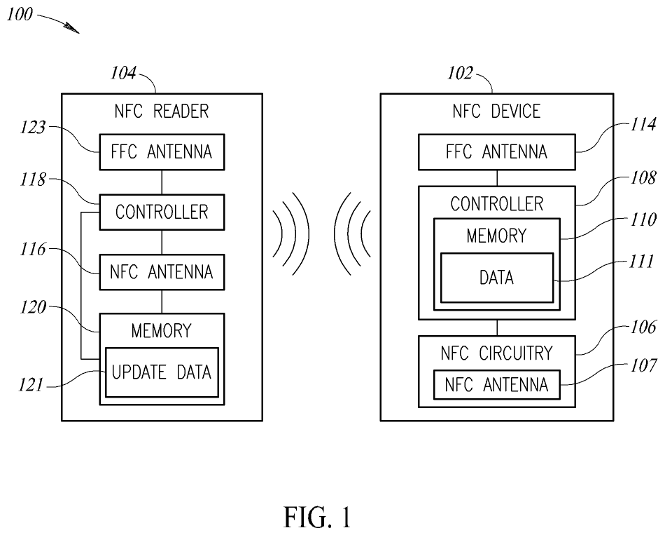

FIG. 1 is a block diagram of an NFC system 100, according to one embodiment. The NFC system 100 includes an NFC device 102 and an NFC reader 104. The NFC device 102 and the NFC reader 104 communicate with each other utilizing NFC technology. As will be set forth in more detail below, the NFC device 102 and the NFC reader 104 cooperate to quickly and efficiently transfer large data files from the NFC device 102 to the NFC reader 104 or from the NFC reader 104 to the NFC device 102.

Prior to describing further details of the NFC system 100, it is beneficial to describe operating characteristics of some NFC devices. A first operating mode of an NFC reader is a read/write mode, hereafter referred to as “reader mode”. In the reader mode, the NFC reader outputs a carrier field corresponding to a radiofrequency signal that facilitates NFC communication. The NFC reader outputs an interrogation signal by modulating the carrier field. If an NFC device is in proximity to the NFC reader, the NFC device may receive the interrogation signal. The interrogation signal induces a response from the NFC device. Once communication is established between the NFC device and the NFC reader, the NFC reader may read data from the NFC device or may provide data to the NFC device.

As used herein, an “NFC device” is a device that includes NFC functionality. As used herein, an “NFC device” may operate as an NFC tag or in another manner when interacting with an NFC reader in reader mode. The NFC device receives the carrier field and interrogation signal from an NFC device and responds by providing data to the NFC device by NFC or by receiving data from the NFC reader by NFC. An NFC device may act as a tag in some instances and as an NFC reader in other instances.

As used herein, an “NFC reader” is a device that includes NFC functionality and that may output an NFC carrier field to read or receive data from an NFC device. An NFC reader may correspond to an electronic device that has primary functions other than acting as an NFC reader. The NFC reader may act as an NFC reader in some circumstances and is an NFC device in other circumstances.

The NFC device 102 includes an NFC circuitry 106, a controller 108, and an FFC antenna 114. The components of the NFC device 102 cooperate together to provide NFC communication.

As used herein, the term “FFC” may correspond to communication in frequency ranges between 500 MHz and 60 GHz. In particular, the term “FFC” is used herein to refer to communication protocols or components that can communicate at ranges significantly larger than typical NFC communication ranges and that have frequencies that are much higher than traditional NFC frequencies. Whereas NFC communication typically occurs at ranges less than 15 cm, FFC communication may occur at ranges up to 50 m or more. Some examples of FFC communication are Wi-Fi communication and Bluetooth communication, though other communication protocols can be utilized for FFC without departing from the scope of the present disclosure. In the example of Wi-Fi communication, FFC may be performed at 2.4 GHz, 5 GHZ, or 6 GHZ, depending on standards. In the example of Bluetooth communication, FFC may be performed at frequencies between 2.4 GHz and 2.5 GHz depending on standards.

The NFC circuitry 106 enables the NFC device 102 to transmit signals and to receive signals. The NFC circuitry 106 can include an NFC antenna 107 for transmitting NFC signals and for receiving NFC signals. The NFC circuitry 106 can include additional circuitry for enabling the NFC circuitry 106 to receive signals including interrogation signals, carrier fields, and other types of signals. The NFC circuitry 106 can include additional circuitry for enabling the NFC circuitry 106 to receive and process signals including interrogation signals and other types of signals from various types of NFC readers. The NFC circuitry 106 can include circuitry for harvesting energy from an external NFC field in order to power the NFC circuitry. While the controller 108 is shown as being separate from the NFC circuitry 106, in practice, the controller 108 may be part of the NFC circuitry 106.

The controller 108 includes control circuitry for controlling the function of the NFC device 102. The controller 108 controls the operation of the NFC circuitry 106. The controller 108 controls the reception and transmission of signals with the NFC circuitry 106. The controller 108 can include processing resources, memory resources, and data transmission resources. The controller 108 may correspond to a microcontroller, a microprocessor, or other types of controllers or processors.

The controller 108 includes a memory 110. The memory 110 may include electrically erasable and programmable read-only memory (EEPROM), random access memory (RAM), and other types of memory. The EEPROM can include flash memory or other types of memory. The RAM may include static RAM (SRAM), dynamic RAM (DRAM), or other types of RAM.

The memory 110 stores data 111. The data 111 may include software, such as firmware data, that controls the basic function of the controller 108. In other examples, the data 111 can include other types of data aside from firmware data. The data may act as the operating system of the NFC device 102. The data 111 can include instructions protocols for performing the operations, processes, and methods executed by the NFC device 102, including those described herein. As will be set forth in more detail below, the components of the NFC system 100 cooperates to update the data 111 in the memory 110. While some embodiments described herein are directed to firmware data, other types of data 111 can be updated without departing from the scope of the present disclosure.

While some embodiments describe updating data of a memory 110 of a controller 108, the memory 110 may external to a controller. Furthermore, the data 111 can include photographs, videos, documents, software, or other types of data. Such data can be added to or replaced using the update processes described herein.

While the embodiment of FIG. 1 illustrates a controller that is part of the NFC device 102, the controller may also be part of a device or system that hosts the NFC device 102. The processes described here for updating the data can be utilized to update the data for other components of an electronic device or system that hosts the NFC device 102. The data associated with these other controllers may be more complex than the data 111 associated with the NFC device 102.

From time to time it may be beneficial to update the data 111 of the controller 108. In many instances it may be difficult to update the data 111 of a controller associated with an NFC device. This may be particularly true when an NFC device is part of a device that is not commonly connected to the Internet, or that does not have a ready interface that allows the user to navigate the Internet to update data. Furthermore, in some cases it may be desirable to provide other types of data, such as images, videos, music, or other types of data to the memory of an NFC device.

In one example, an NFC device is part of an electronic device. The electronic device may not have any internal power source, such as a battery. In some cases, the electronic device may have a power source but the NFC device 102 is not connected to the power source of the electronic device. In these cases, the NFC device 102 is powered entirely by harvesting energy from an external NFC field output by an NFC reader 104.

It very difficult to update the firmware or to provide large data files to an NFC device, that does not have an internal power source or is not setup for a wired data transfer connection. One solution is to provide the update data from an NFC reader to an NFC device via NFC. However, in many cases the firmware update may include a relatively large amount of data. Updating the firmware via NFC may take a relatively large amount of time. Furthermore, if the NFC device and the NFC reader are moved out of NFC range during the firmware update process, then the firmware update may fail and may need to be restarted. This can be very inconvenient to individual performing the firmware update.

The NFC system 100 overcomes the drawbacks and difficulties associated with other solutions for updating firmware of controllers. The NFC device 102 and the NFC reader 104 of FIG. 1 provide a convenient, efficient, and effective way to update the data 111 of the controller 108 associated with the NFC device 102. In particular, the NFC device 102 utilizes the FFC antenna 114 to facilitate rapid and reliable updates of the controller 108 or to otherwise provide large data files to the NFC device 102.

The NFC reader 104 plays a role in updating the data 111 of the NFC device 102. The NFC reader 104 includes an NFC antenna 116, controller 118, a memory 120, and an FFC antenna 123. The NFC antenna 116 includes antennas and other circuitry for receiving signals from the NFC device 102 and for providing signals to the NFC device 102. The NFC antenna 116 may be part of an NFC transceiver of the NFC reader 104.

The controller 118 may control the operation of the NFC antenna 116. The controller 118 may control the output of a carrier field. The controller may control modulation of the carrier field to output an interrogation signal, to output one or more commands, to output various identification signals, or to provide other types of data. The controller 118 may also control reception and processing of signals received from the NFC device 102.

The carrier field is a radiofrequency signal that facilitates NFC communication. The NFC device 102 outputs an interrogation signal by modulating the carrier field. The interrogation signal is configured to induce a response from NFC readers that are in communication range with the NFC device 102. If the NFC reader 104 is within range of the NFC device 102, then the NFC reader 104 can respond to the interrogation signal. In one embodiment, the NFC reader 104 outputs a carrier field with the standard central frequency of 13.56 MHz. However other frequencies can be utilized by the NFC reader 104 without departing from the scope of the present disclosure. As used herein, the terms “carrier field” and “NFC field” may be used interchangeably.

The memory 120 may store software instructions associated with operating the NFC reader 104. Though not shown in FIG. 1, the memory 120 may include firmware data of the controller 118. The memory 120 can include the same types of memories described in relation to the memory 110 of the NFC device 102, or may include other types of memory.

The memory 110 may store a unique identification (UID) of the NFC tag 102. The UID is identification code associated with the NFC tag 102. The UID may also identify the type of the NFC tag 102. As will be set forth in more detail below, the UID may be read by the NFC reader 104 in order to authenticate the NFC tag 102.

The memory 110 may also store data in accordance with an NFC Data Exchange Format (NDEF). Such data can facilitate FFC pairing, such as Bluetooth pairing, Wi-Fi pairing, or other types of FFC pairing. Some example of NDEF records can include Blootooth pairing data, universal resource identifier data, text data, short messaging service (SMS) data, smart poster data, or other types of data or records. The type of NDEF record is defined in the record type definition (RTD) field, located in the NDEF header. One type of NDEF record used for Bluetooth handover is a multipurpose Internet mail extensions (MIME) type record. Various types of NDEF data can be stored and utilized by the NFC tag 102 for data exchange to facilitate pairing, identification, or for other actions.

The NFC reader 104 is configured to receive update data 121. The NFC reader 104 stores the update data 121 in the memory 120. The update data 121 corresponds to data that will replace or augment the data 111 of the controller 108. Accordingly, in some embodiments the update data 121 corresponds to a replacement for the data 111 of the controller 108. In embodiments in which the data 111 is firmware data, the update data 121 is firmware update data. In some embodiments, the update data 121 includes large data files such as image data, video data, music data, text data, software data, or other types of data. Data may be transmitted from the NFC reader 104 to the NFC device 102, or from the NFC device 102 to the NFC reader 104. For example, video data may be transferred from the NFC reader 104 to the NFC device 102, or from the NFC device 102 to the NFC reader 104.

The NFC reader 104 may receive the update data via the Internet, via a network connection, or in other ways. In one example, the NFC reader 104 is a device that includes a user interface and an application associated with the NFC device 102. The application may prompt the user of the NFC reader 104 to download update data 121 in preparation for performing an update process of the controller 108. The user may then accept the update data 121 or may otherwise select to download the update 121. In another example, an application associated with the NFC reader 104 may automatically download update data 121 without user input. There are various ways in which an NFC reader 104 may receive update data 121.

In one embodiment, the NFC reader 104 is a smart phone. The smart phone may include an application associated with the NFC device 102. The application may download update data 121 for the controller 108. Alternatively, the user may utilize an application to accept or request download of the update data 121. The NFC reader 104 can include smart watch, a tablet, and NFC card, an NFC tag, or other types of electronic devices that include NFC capability.

After the NFC reader 104 has downloaded or otherwise received the update data 121, the user of the NFC reader 104 brings the NFC reader 104 into proximity of the NFC device 102. The NFC reader 104 outputs a carrier field and modulates the carrier field to generate an interrogation signal. The device 102, operating as an NFC tag, or in an NFC tag emulation mode, receives the interrogation signal and is induced to respond to the interrogation signal. Initially, the NFC reader 104 reads an identification from the NFC device 102, for example a UID. After authenticating the NFC device 102, the NFC device 102 provides an AID to the NFC reader 104 by modulating the NFC field. The AID indicates that the NFC reader 104 wishes to provide update data 121 to the NFC device 102. The data transmission may be from the NFC reader 104 to the NFC device 102 or from the NFC device 102 to the NFC reader 104

When the NFC device 102 receives the indication that the NFC reader 104 is ready to provide update data 121, the NFC device 102 may provide FFC address data to the NFC reader 104. The FFC address data corresponds to an FFC address associated with the NFC device 102. The NFC device 102 may provide the address data by modulating an impedance of the NFC antenna 107. The NFC reader receives the address data by detecting the modulation of the impedance of the NFC antenna 107. Throughout this process, the NFC circuitry 106 harvests energy from the NFC field provided by the NFC reader 104. The NFC circuitry 106 generates a voltage from the energy harvested from the NFC field. The NFC circuitry 106 provides the voltage to the controller 108 so that the controller 108 can operate the FFC antenna 114 to receive data.

After the NFC reader 104 receives the FFC address data of the NFC device 102, the controller 118 controls the FFC antenna 123 to establish and FFC connection with the FFC antenna 114 of the NFC device 102. After the NFC reader 104 and the NFC device 102 established in FFC connection, the NFC reader 104 proceeds to provide the update data 121 to the NFC device 102. The controller 108 of the NFC device 102 receives the update data 121 via the NFC antenna 114. The controller 108 then updates the data 111 with the update data 121. Alternatively, update data can be provided from the NFC device 102 to the NFC reader 104

Because the NFC device 102 does not include its own power source, the controller 108 controls the FFC antenna 114 to establish the FFC connection and to send or receive the update data, while being powered by the voltage provided by the NFC circuitry 106. The NFC circuitry 106 generates the voltage by harvesting energy from the carrier field provided by the NFC antenna 116 of the NFC reader 104. The update of the controller 108 can be performed very rapidly. For example, the update can be performed in less than two seconds utilizing FFC communication rather than NFC communication. This is highly advantageous because a user of the NFC reader 104 may hold the NFC reader 104 in place for only a few seconds or less in order to perform the update. Once the update has been accomplished, the NFC device 102 can output a signal via the FFC antenna 114 indicating that the update has been accomplished successfully. The NFC reader 104 can then output an indication to a user of the NFC reader 104 that the update process is complete.

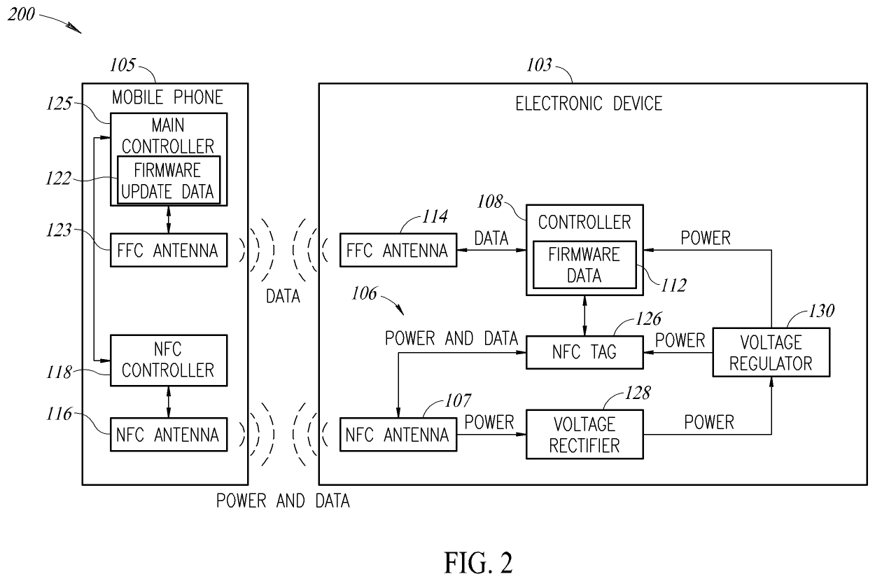

FIG. 2 is a block diagram of an NFC system 200, according to one embodiment. The NFC system includes an electronic device 103 and a mobile phone 105. The electronic device 103 is one example of an NFC device 102 of FIG. 1. Alternatively, the electronic device 103 can be regarded as including the NFC device 102. The mobile phone 105 is one example of an NFC reader 104 of FIG. 1. The electronic device 103 and the mobile phone 105 cooperate to update the firmware of the controller 108 or exchange data between 103 and 105.

The mobile phone 105 of FIG. 2 is substantially similar to the NFC reader 104 of FIG. 1. While FIG. 2 utilizes a mobile phone 105, other types of NFC devices can be utilized to provide firmware updates to the electronic device 103. The mobile phone is substantially similar to the NFC reader 104 of FIG. 1, except that the mobile phone 105 includes a main controller 125 in addition to the NFC controller 118. In practice, the mobile can controller 125 may be a general controller of the mobile phone 105. The main controller 125 may push firmware update data 122 to the electronic device 103, after FFC communication has been established.

The electronic device 103 is a device or system that hosts the NFC device 102. The electronic device 103 includes a controller 108 that controls the NFC device 102. The controller 108 can include a microprocessor, a microcontroller, or another type of controller. The controller 108 includes firmware data 112. The firmware data 112 is one example of data 111 of FIG. 1.

The electronic device 103 includes NFC circuitry 106. The NFC circuitry 106 includes an NFC antenna 107, an NFC tag 126, a voltage rectifier 128, and a voltage regulator 130. The NFC tag 126 is coupled to the controller 108. The electronic device 103 also includes an FFC antenna 114 is coupled to the controller 108. The controller 108 is configured to implement the FFC communication protocol with the FFC antenna 114.

When the mobile phone 105 is utilized to interact with the electronic device 103, the mobile phone 105 outputs an NFC field and via the NFC antenna 116. As described previously, the NFC antenna 116 may modulate the NFC field in order to output an interrogation signal, identification data command data, application identification data, or other types of data. The NFC antenna 107 receives the carrier signal and provides the carrier signal to the voltage rectifier 128 and to the NFC tag 126. The voltage rectifier 128 rectifier is the carrier field in order to generate a rectified voltage. The rectified voltage can correspond to a DC voltage. The voltage rectifier 128 provides the rectified voltage regulator 130.

The voltage regulator 130 receives the rectified voltage and generates a regulated voltage from the rectified voltage. The regulated voltage can correspond to a standard supply voltage that can be provided to the NFC tag 126 and to the controller 108. One example, regulated voltages between two old files, though other voltages can be utilized without departing from the scope of the present disclosure.

The NFC tag 126 can include a memory that stores data such as identification data or address data. The NFC tag is powered by the regulated voltage and receives the modulating carrier signal. The NFC tag 126 may modulate the impedance of the antenna 107 in order to output identification data address data or other types of data from the NFC antenna 107 as described in relation to FIG. 1.

The NFC tag may also provide the data to the controller 108. If the data indicates that a firmware update is available, the controller 108 may enter an FFC communication mode to facilitate the FFC antenna 114 establishing an FFC communication with the FFC antenna 123 of the mobile phone 105, as described in relation to FIG. 1. When the mobile phone 105 receives FFC address data via the NFC connection, then the mobile phone 105 can utilize the FFC address data to establish an FFC connection with the antenna 114. The mobile phone 105 can then push firmware update data 122 from the mobile phone 105 to the electronic device 103. The controller 108 can then update the firmware data 112 with the firmware update data 122. The firmware update data 122 is one example of the update data 121 of FIG. 1.

While examples herein describe providing firmware update data from the mobile phone 105 to the electronic device 103, other types of data can be provided. For example, rather than firmware update data 122, other types of software update data can be provided from the mobile phone 105 to the electronic device 103. Various types of data can be provided via the FFC communication from the mobile phone 105 to the electronic device 103. Alternatively, data can be transmitted from the electronic device 103 to the mobile phone 105.

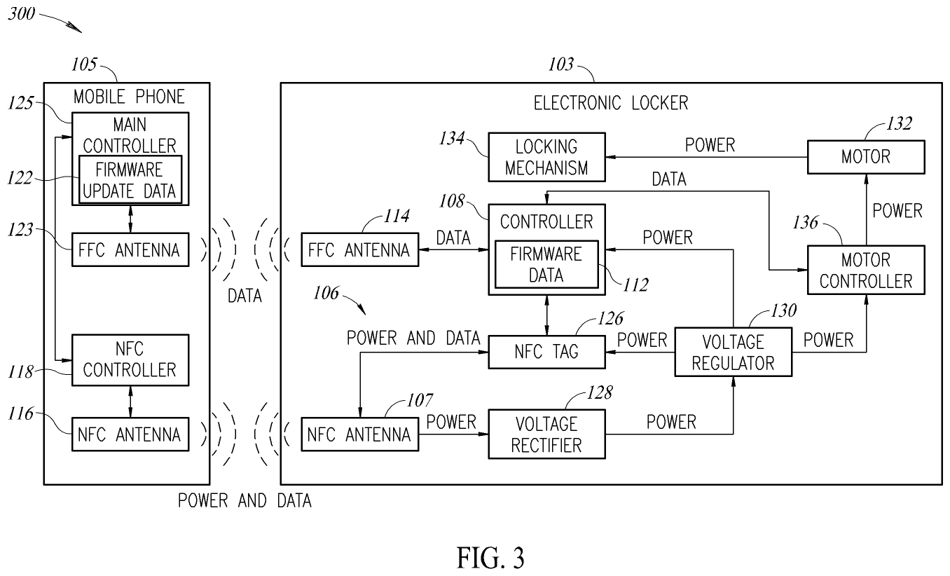

FIG. 3 is a block diagram of an NFC system 300, according to one embodiment. The NFC system includes an electronic locker 103 and a mobile phone 105. The electronic locker 103 and the mobile phone 105 cooperate to update the firmware of the controller 108 of the electronic locker 103.

The mobile phone of FIG. 3 is substantially identical to the mobile phone 105 of FIG. 2. In particular, the mobile phone 103 can communicate with the electronic locker 103 via both NFC and FFC. The mobile can provide firmware update data 122 to the electronic locker 103 via FFC.

The electronic locker 103 is one example of an electronic device 103 of FIG. 2. The electronic locker 103 includes NFC circuitry 106, a controller 108, and an FFC antenna as described in relation to FIG. 2. The electronic locker 103 further includes a motor 132, a locking mechanism 134, and the motor controller 136.

In one embodiment, the electronic locker 103 may act as a padlock or other type of lock. However, unlike traditional locks in which a key or a manual combination are used to unlock the lock, the electronic locker 103 is unlocked only by NFC. The mobile phone 105 utilizes NFC is a key to unlock the electronic locker 103. In particular, the mobile phone 105 and the electronic locker 103 establish NFC communication as described previously. When the mobile phone 105 receives an identification from the electronic locker 103, the mobile phone 105 can then provide an identification signal for unlocking the locking mechanism 134. The NFC tag 126 or the controller 108 authenticates the identification signal from the mobile phone 105. If the identification signal is valid, then the controller 108 controls the motor controller 136 to activate the motor 132. The motor 132 moves the locking mechanism 134 to unlock the electronic locker 103. The motor controller 136 is powered by the regulated voltage from the voltage regulator 130. While FIG. 3 illustrates a mobile phone 105, an NFC capable device other than a mobile phone can be utilized in place of the mobile phone 105.

As described previously, in some instances, the mobile phone 105 may be utilized to update the firmware data 112 of the controller 108 via FFC. The updating of the firmware can occur substantially as described in relation to FIGS. 1 and 2.

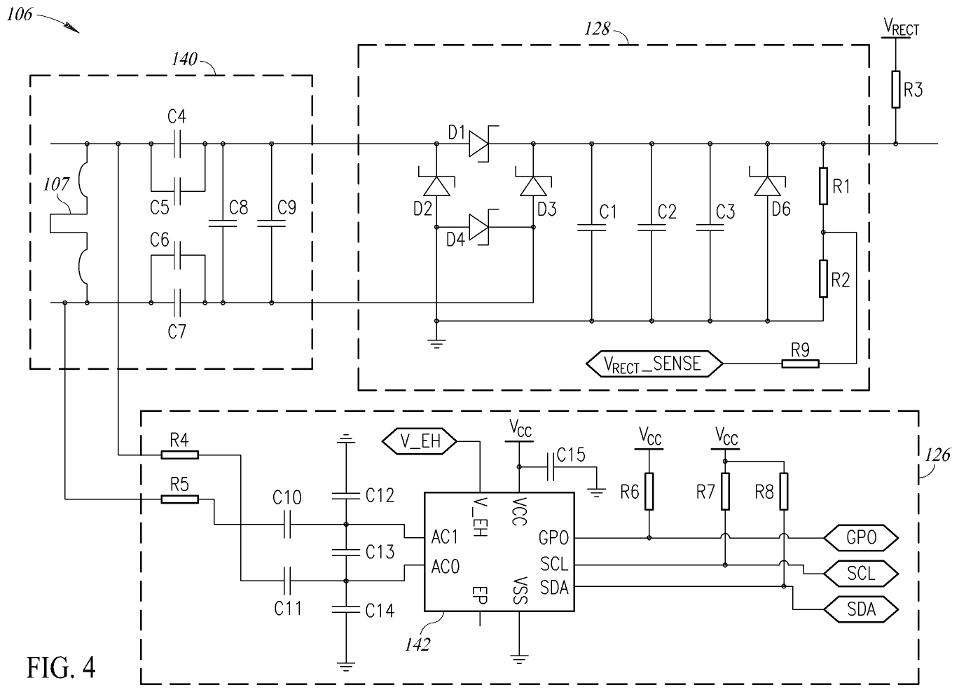

FIG. 4 is a schematic diagram of NFC circuitry 106, according to one embodiment. The NFC circuitry 106 includes matching circuitry 140, a rectifier 128, and an NFC tag 126. The matching circuitry 140 includes an NFC antenna 107 and the plurality of capacitors C4-C9. The antenna 107 can correspond to the primary NFC antenna by which a carrier field is received from an NFC reader 104. The capacitors C4 and C5 are connected to a first terminal of the NFC antenna 107 and in parallel with each other. The capacitors C6 and C7 are connected to a second terminal of the NFC antenna 107 and in parallel with each other. The capacitors C8 and C9 are connected in parallel to each other between the capacitors C4 and C7. The matching network circuitry 140 can help ensure reliable power transfer from the antenna 107.

The voltage regulator 128 includes diodes D1-D4 that perform initial rectification of the carrier field. The diodes D1-D4 are connected in a bridge configuration. The anodes of the diodes D2 and D4 are coupled to ground. The cathodes of the diodes D1 and D3 provide a rectified voltage Vrect. The anode of the diode D1 and the cathode of the diode D2 are coupled to the capacitors C4 and C5. The anode of the diode D3 and the cathode of the diode D4 are coupled to the capacitors C6 and C7.

A diode D6 is also coupled between ground and the rectified voltage Vrect. The capacitors C1-C3 are coupled in parallel to each other between ground and the rectified voltage Vrect. A pair of resistors R1 and R2 are coupled as a voltage divider between ground and Vrect. The divided voltage is provided, via a resistor R9 to a sensing terminal Vrect_SENSE that can be utilized to sense the rectified voltage. The rectified voltage also passes the resistor R3. Though not shown in FIG. 4, a voltage regulator 130 may receive the rectified voltage Vrect and may generate a regulated voltage. The regulated voltage may be a supply voltage VCC.

The tag 126 includes a chip 142. The chip 142 includes antenna terminals AC1 and AC0. AC1 is coupled to a first terminal of the NFC antenna 107 via a resistor R5 and the capacitor C10. AC0 is coupled to the second terminal of the NFC antenna 107 via a resistor R4 and a capacitor C11. A capacitor C12 is coupled between AC1 and ground. A capacitor C14 is coupled between AC0 and ground. The capacitor C13 is coupled between C12 and C14. A capacitor C13 is coupled between C12 and C14. The chip 142 reads data from the modulated carrier field via AC1 and AC0. The chip 142 can also output data to the antenna 107 via AC1 and AC0

The chip 142 may also include terminals V_EH, VCC, VSS, GPO, SCL, SDA, and EP. V_EH may correspond to an energy harvesting output. The terminal VCC is a supply terminal that receives the supply voltage VCC from the voltage regulator 130. VSS is coupled to ground. GPO is an interrupt output. SDA is a serial data input/output that can be coupled to the controller 108. SCL is serial clock terminal that can be coupled to a clock (not shown). EP is coupled to an exposed pad that is left floating. A capacitor C15 is coupled between VCC and ground. A resistor R6 is coupled between GPO and ground. A resistor R7 is coupled between SCL and ground. A resistor R8 is coupled between SDA and ground. The chip 142 may store identification data of the NFC device and may store address data for FFC communication. The chip 142 may be controlled by the controller 108. Other configurations of NFC circuitry 106 may be utilized without departing from the scope of the present disclosure.

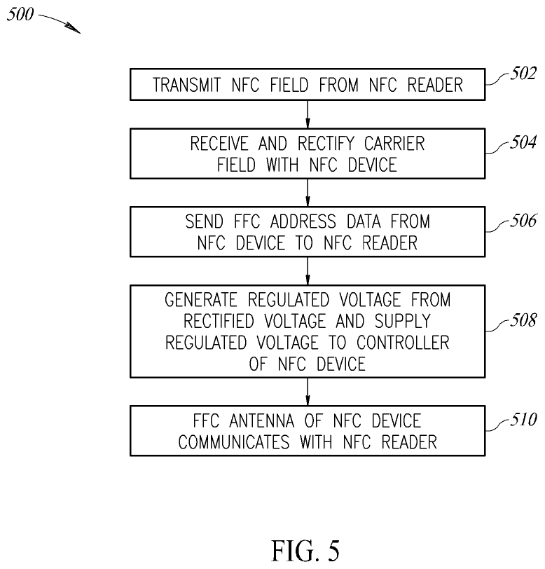

FIG. 5 is a flow diagram of a method 500 for operating an NFC system, according to one embodiment. The method 500 can utilize the systems, components, and processes described in relation to FIGS. 1-4. At 502, the method 500 includes transmitting an NFC field from an NFC reader. At 504, the method 500 includes receiving and rectifying the carrier field with an NFC device. At 506, the method 500 includes sending FFC address data from the NFC device to the NFC reader. At 508, the method 500 includes generating a regulated voltage from the rectified voltage and supplying the regulated voltage to the controller of the NFC device. At 510, the method 500 includes communicating with the NFC reader via the FFC antenna of the NFC device.

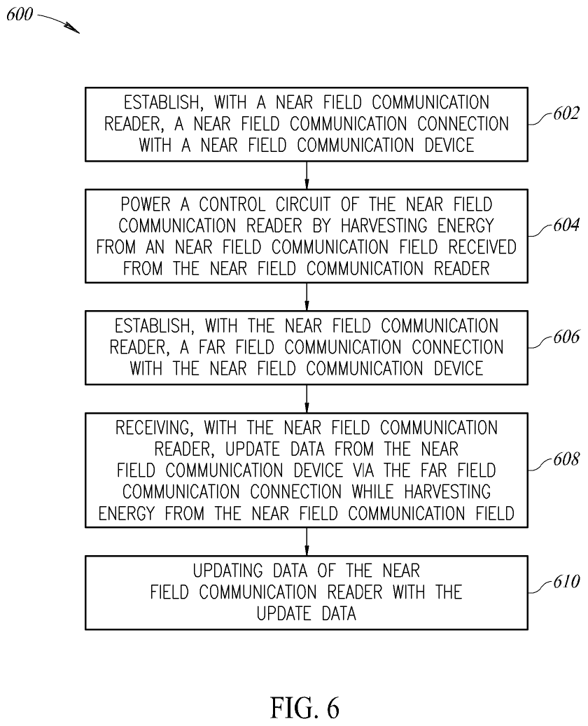

FIG. 6 is a flow diagram of a method 600 for operating an NFC system, according to one embodiment. The method 600 can utilize the systems, components, and processes described in relation to FIGS. 1-5. At 602, the method 600 establishing, with an NFC device, a near field communication connection with an NFC reader. At 604, the method 600 includes powering a controller of the NFC device by harvesting energy from an NFC field received from the NFC device. At 606, the method 600 includes establishing, with the NFC device, a far field communication connection with the NFC reader. At 608, the method 600 includes receiving, with the NFC device, update data from the NFC reader via the far field communication connection while harvesting energy from the NFC field. At 610, the method 600 includes updating data of the NFC device with the update data.

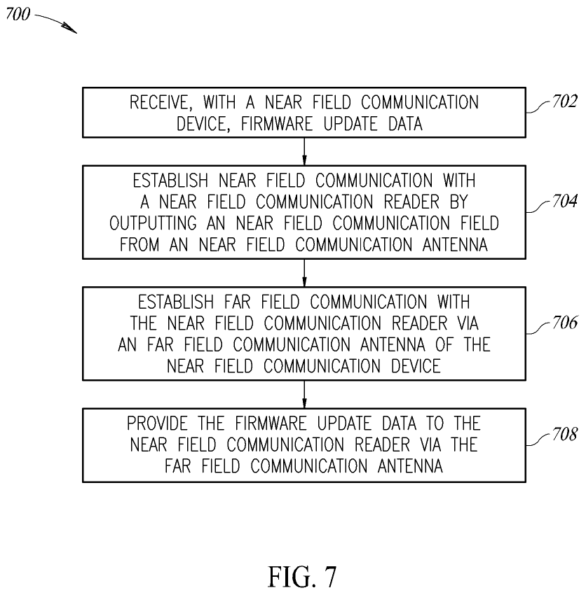

FIG. 7 is a flow diagram of a method 700 for operating an NFC system, according to one embodiment. The method 700 can utilize the systems, components, and processes described in relation to FIGS. 1-6. At 702, the method 700 includes receiving, with an NFC reader, firmware update data. At 704, the method 700 includes establishing near field communication with an NFC device by outputting an NFC field from an NFC antenna. At 706, the method 700 includes establishing FFC communication with the NFC device via an FFC antenna of the NFC reader. At 708, the method 700 includes providing the firmware update data to the NFC device via the FFC antenna.

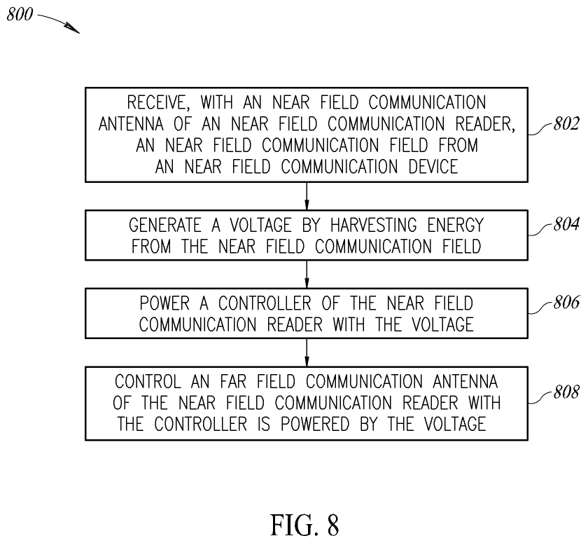

FIG. 8 is a flow diagram of a method 800 for operating an NFC system, according to one embodiment. The method 800 can utilize the systems, components, and processes described in relation to FIGS. 1-6. At 802, the method 800 includes receiving, with an NFC antenna of an NFC device, an NFC field from an NFC reader. At 804, the method 800 includes generating a voltage by harvesting energy from the NFC field. At 806, the method 800 includes powering a controller of the NFC device with the voltage. At 808, the method 800 includes controlling an FFC antenna of the NFC device with the controller is powered by the voltage.

In one embodiment, a method includes establishing, with an NFC device, a near field communication connection with an NFC reader, powering a controller of the NFC device by harvesting energy from an NFC field received from the NFC device, and establishing, with the NFC device, a far field communication connection with the NFC reader. The method includes receiving, with the NFC device, update data from the NFC reader via the far field communication connection while harvesting energy from the NFC field and updating data of the NFC device with the update data.

In one embodiment, an electronic system includes NFC circuitry including an NFC antenna, an FFC antenna, and a controller coupled to the NFC circuitry and to the NFC antenna.

In one embodiment, an electronic lock includes NFC circuitry including an NFC antenna, an FFC antenna, and a controller coupled to the NFC circuitry and to the NFC antenna. The electronic lock includes a motor coupled to the controller and a locking mechanism coupled to the motor.

In one embodiment, an electronic system includes an NFC reader configured to receive firmware update data. The NFC reader includes a first NFC antenna and a first FFC antenna. The system includes an NFC device. The NFC device includes NFC circuitry. The NFC circuitry includes a second NFC antenna, a second FFC antenna, and a controller coupled to the NFC circuitry and the second FFC antenna.

In one embodiment, an electronic device includes an NFC antenna, an FFC antenna, and a controller coupled to the NFC antenna and the FFC antenna. The controller is configured to cause the NFC antenna to output an NFC field to establish an NFC connection with an NFC device and to establish an FFC connection with NFC device via the FFC antenna while the NFC antenna outputs the NFC field.

In one embodiment, a method includes receiving, with an NFC reader, firmware update data and establishing near field communication with an NFC device by outputting an NFC field from an NFC antenna. The method includes establishing FFC communication with the NFC device via an FFC antenna of the NFC reader and providing the firmware update data to the NFC device via the FFC antenna.

In one embodiment, a method includes receiving, with an NFC antenna of an NFC device, an NFC field from an NFC reader and generating a voltage by harvesting energy from the NFC field. The method includes powering a controller of the NFC device with the voltage and controlling an FFC antenna of the NFC device with the controller is powered by the voltage.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
establishing, with a near field communication device, a near field communication connection with a near field communication reader;
powering a controller of the near field communication device by harvesting energy from a near field communication field received from the near field communication device;
establishing, with the near field communication device, a far field communication connection with the near field communication reader;
receiving, with the near field communication device, update data from the near field communication reader via the far field communication connection while harvesting energy from the near field communication field; and
updating data of the near field communication device with the update data.

2. The method of claim 1, wherein the far field communication connection is a Wi-Fi connection or a Bluetooth.

3. The method of claim 1, wherein the update data is firmware update data.

4. The method of claim 1, comprising:
receiving, with the near field communication device via the near field communication connection, an indication that an update is available; and
sending, to the near field communication reader with the near field communication device, far field communication address data with the near field communication device responsive to receiving the indication that the update is available.

5. The method of claim 4, comprising:
receiving, with the near field communication device, a far field communication pairing request from the near field communication reader including the far field communication address data; and
establishing the far field communication connection responsive to receiving the far field communication pairing request.

6. The method of claim 1, wherein the near field communication device is part of an electronic device.

7. The method of claim 6, wherein the electronic device is part of an electronic lock, wherein the near field communication reader is a mobile phone.

8. (canceled)

9. The method of claim 1, wherein establishing a near field communication connection with the near field communication reader includes:
receiving an identification of the near field communication reader with the near field communication device;
authenticating, with the near field communication device, the identification of the near field communication;
receiving an application identification of the near field communication reader with the near field communication device; and
identifying that application identification refers to an update process, the method further comprising updating the data of the controller responsive to identifying that that the application identification corresponds to a data update process.

10-11. (canceled)

12. An electronic system, comprising:
near field communication circuitry including a near field communication antenna;
a far field communication antenna; and
a controller coupled to the near field communication circuitry and to the near field communication antenna.

13. The electronic system of claim 12, wherein the near field communication circuitry is configured to establish a near field communication connection with a near field communication reader and to harvest energy from a near field communication field received from the near field communication reader, wherein the near field communication circuitry is configured to power the controller with the energy harvested from the near field communication field.

14. (canceled)

15. The electronic system of claim 13, wherein:
the near field communication circuitry is configured to receive an update request from the near field communication reader and to indicate to the controller than an update request has been received;
the controller is configured to establish a far field communication connection with the near field communication reader via the far field communication antenna;
the controller is configured to receive update data from the near field communication reader via the far field communication antenna.

16. (canceled)

17. The electronic system of claim 15, wherein the controller is configured to update an aspect of the controller with the update data, wherein the near field communication circuitry is configured to power the controller while the controller receives the update data and while the controller updates the aspect of the controller with the update data, wherein the update data includes firmware update data for the controller.

18. (canceled)

19. The electronic device of claim 13, wherein the controller is configured to establish a far field communication connection with the near field communication reader via the far field communication antenna and to provide update data to the near field communication reader via the far field communication antenna.

20. The electronic system of claim 12, comprising:
a motor coupled to the controller and the near field communication circuitry, wherein the controller is configured to activate the motor responsive to receiving valid identification data from the near field communication reader via the near field communication circuitry; and
a locking mechanism coupled to the motor, wherein the motor is configured to lock or unlock the locking mechanism responsive to activation by the controller.

21. (canceled)

22. The electronic system of claim 12, wherein the near field communication circuitry includes:
a near field communication tag coupled to the near field communication antenna and to the controller
a voltage rectifier coupled to the near field communication antenna and configured to harvest energy from the near field communication field by generating a rectified voltage from the near field communication field; and
a voltage regulator coupled to the rectifier and configured to generate a regulated voltage from the rectified voltage and to supply the rectified voltage to the controller and the near field communication tag.

23. The electronic device of claim 12, wherein the controller is not coupled to a battery and is only powered by the energy harvested from the near field communication field.

24. An electronic lock, comprising:
near field communication circuitry including a near field communication antenna;
a far field communication antenna;
a controller coupled to the near field communication circuitry and to the near field communication antenna;
a motor coupled to the controller; and
a locking mechanism coupled to the motor.

25. The electronic lock of claim 24, wherein the near field communication circuitry is configured to establish near field communication with a near field communication reader, to generate a voltage by harvesting energy from a near field communication field received from the near field communication reader, and to power the controller with the voltage, wherein the controller is configured to establish a far field communication connection with the near field communication reader via the far field communication antenna while being powered by the voltage from the near field communication circuitry.

26. The electronic lock of claim 25, wherein the controller is configured to receive firmware update data from the electronic device via the far field communication antenna while being powered by the voltage from the near field communication circuitry.

27. The electronic lock of claim 25, wherein the near field communication circuitry is configured to provide the voltage to the motor, wherein the controller is configured to cause the motor to operate the locking mechanism responsive to the near field communication circuitry receiving a valid identification from the near field communication reader.

28-40. (canceled)
